(19) United States
(12) Patent Application Publication
(10) Pub. No.: US 2013/0217447 A1
(43) Pub. Date: Aug. 22, 2013

(54) ELECTRONIC EQUIPMENT, STORAGE MEDIUM AND OUTPUT CONTROLLING METHOD

(71) Applicant: KYOCERA Corporation, (US)

(72) Inventor: Yasuyuki SAKAMOTO, Osaka (JP)

(73) Assignee: KYOCERA CORPORATION, Kyoto-shi (JP)

(21) Appl. No.: 13/772,691

(22) Filed: Feb. 21, 2013

(30) Foreign Application Priority Data
Feb. 21, 2012 (JP) 2012-034998

(51) Int. Cl. H04M 1/60

(52) U.S. Cl. CPC H04M 1/60
USPC 455/571

(57) ABSTRACT

A mobile phone which is an example of electronic equipment includes a processor, and when a PTT conversation is started, in the processor, a DSP starts an input and an output under instructions by a control circuit. The processor (control circuit) keeps stopping an output from an amplifier provided at a preceding stage of a speaker, if and when a floor is gotten by a user himself/herself. On the other hand, if and when a floor is gotten by any other person, the processor starts the output of the amplifier, and stops the output when the floor is released by the other person.

### CROSS REFERENCE OF RELATED APPLICATION

The disclosure of Japanese Patent Application No. 2012-034998 filed on Feb. 21, 2012 is incorporated herein by reference.

### BACKGROUND OF THE INVENTION

1. Field of the Invention

The present invention relates to electronic equipment, a storage medium and an output controlling method, and more specifically, electronic equipment performing a communication with any other electronic equipment, and a storage medium and an output controlling method therefor.

2. Description of the Related Art

In a conventional PTT (Push-To-Talk) communication system, when the PTT is being performed, in each terminal, an output of a speaker is kept on irrespective of presence or absence of a floor, and accordingly, in a situation that a floor is owned by a user his/herself or no one has a floor, a noise (white noise) may be generated because no sound or voice is output from the speaker.

### SUMMARY OF THE INVENTION

Therefore, electronic equipment, storage medium and output controlling method, capable of preventing a noise from being generated from a speaker are desirable.

A first aspect according to the present invention is electronic equipment which performs a half-duplex communication with one or more other equipment, comprising: an outputting module which outputs a voice corresponding to a received voice signal; an amplifying module which is provided at a preceding stage of the outputting module and amplifies the received voice signal; an amplifying controlling module which starts an output of the amplifying module when a floor is gotten by any other equipment, and stops the output of the amplifying module at least a time when a floor is not gotten by any other equipment.

A second aspect according to the present invention is a non-transitory computer readable storage medium storing an output controlling program executable by a processor of electronic equipment performing a half-duplex communication with one or more other equipment, wherein the output controlling program causes the processor to perform: starting an output of the amplifying module which is provided at a preceding stage of the outputting module and amplifies a received voice signal when a floor is gotten by any other equipment, and stopping the output of the amplifying module at least a time when the floor is not gotten by any other equipment.

A third aspect according to the present invention is an output controlling method in electronic equipment performing a half-duplex communication with one or more other equipment, comprising steps of: starting an output of the amplifying module which is provided at a preceding stage of the outputting module and amplifies a received voice signal when a floor is gotten by any other equipment, and stopping the output of the amplifying module at least a time when the floor is not gotten by any other equipment.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing electrical structure of a mobile phone of an embodiment according to the present invention.

FIG. 2 is a block diagram showing electrical structure of an inside of a processor shown in FIG. 1 and portions related to an input and an output of a voice.

FIG. 3 is a view showing an example of a PTT conversation system using the mobile phone shown in FIG. 1.

FIG. 4 is a view showing an example of a memory map of a RAM shown in FIG. 1.

FIG. 5 is a flowchart showing a first part of a PTT conversation process by the processor (control circuit) shown in FIG. 2.

FIG. 6 is a flowchart showing a second part of the PTT conversation process by the processor (control circuit) shown in FIG. 2.

FIG. 7 is a flowchart showing a third part of the PTT conversation process by the processor (control circuit) shown in FIG. 2.

FIG. 8 is a flowchart showing a fourth part of the PTT conversation process by the processor (control circuit) shown in FIG. 2.

FIG. 9 is a flowchart showing a fifth part of the PTT conversation process by the processor (control circuit) shown in FIG. 2.

FIG. 10 is a flowchart showing a sixth part of the PTT conversation process by the processor (control circuit) shown in FIG. 2.

FIG. 11 is a flowchart showing a seventh part of the PTT conversation process by the processor (control circuit) shown in FIG. 2.

FIG. 12 is a flowchart showing an eighth part of the PTT conversation process by the processor (control circuit) shown in FIG. 2.

### DETAILED DESCRIPTION OF THE PREFERRED EMBODIMENTS

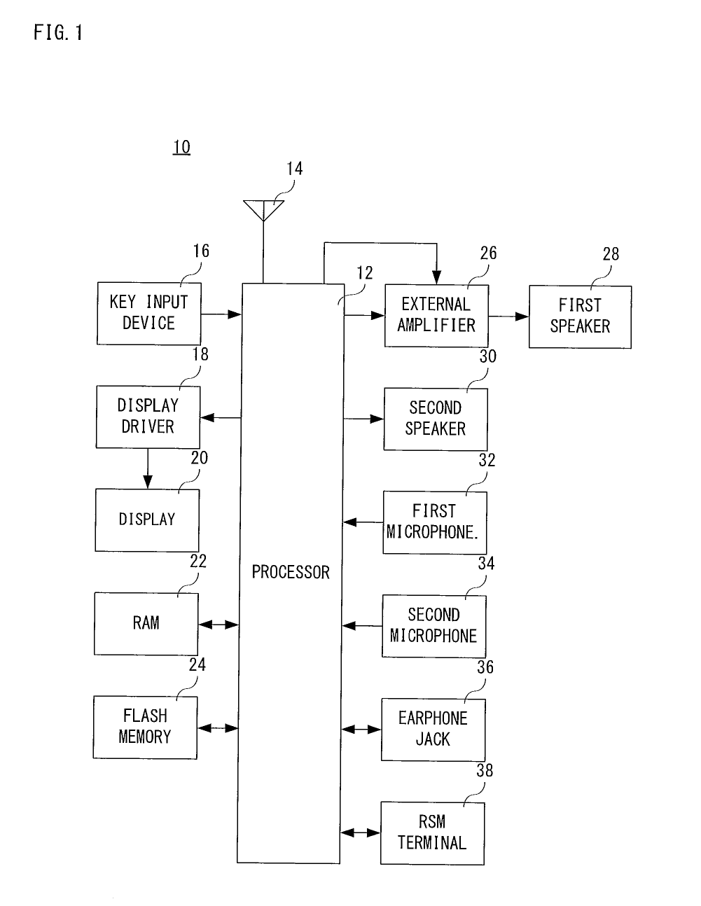

With referring to FIG. 1, a mobile phone 10 as an example of electronic equipment of an embodiment includes a processor 12 which is connected with an antenna 14, a key input device 16, a display driver 18, a RAM 22, a flash memory 24, an external amplifier 26, a second speaker 30, a first microphone 32, a second microphone 34, an earphone jack 36 and an RSM (Remote Speaker Microphone) terminal 38. The display driver 18 is connected with a display 20, and a first speaker 28 is connected to the external amplifier 26.

The processor 12 is also called as a computer or a base band chip, and includes a plurality of circuits so as to take charge of the whole control of the mobile phone 10. The RAM 22 is utilized as a working area (including an image drawing area) or a buffer area for the processor 12. In the flash memory 24, data of an address book in which a name, a telephone number, an email address, etc., of the other end of telephone conversation or communication are included, and data of contents such as a character, an image, a voice, a sound and a video are recorded.

The key input device 16 is also called as an operating module, and includes a PTT button, a dial key, a talk key, a function key, an end key, etc. Furthermore, information (key data) of a key which is operated by a user is input to the processor 12.

The display driver 18 controls, under instructions by the processor 12, the displaying of the display 20 such as an LCD. The display driver 18 includes a video memory (VRAM) which temporarily stores image data corresponding to an image to be displayed on the display 20.

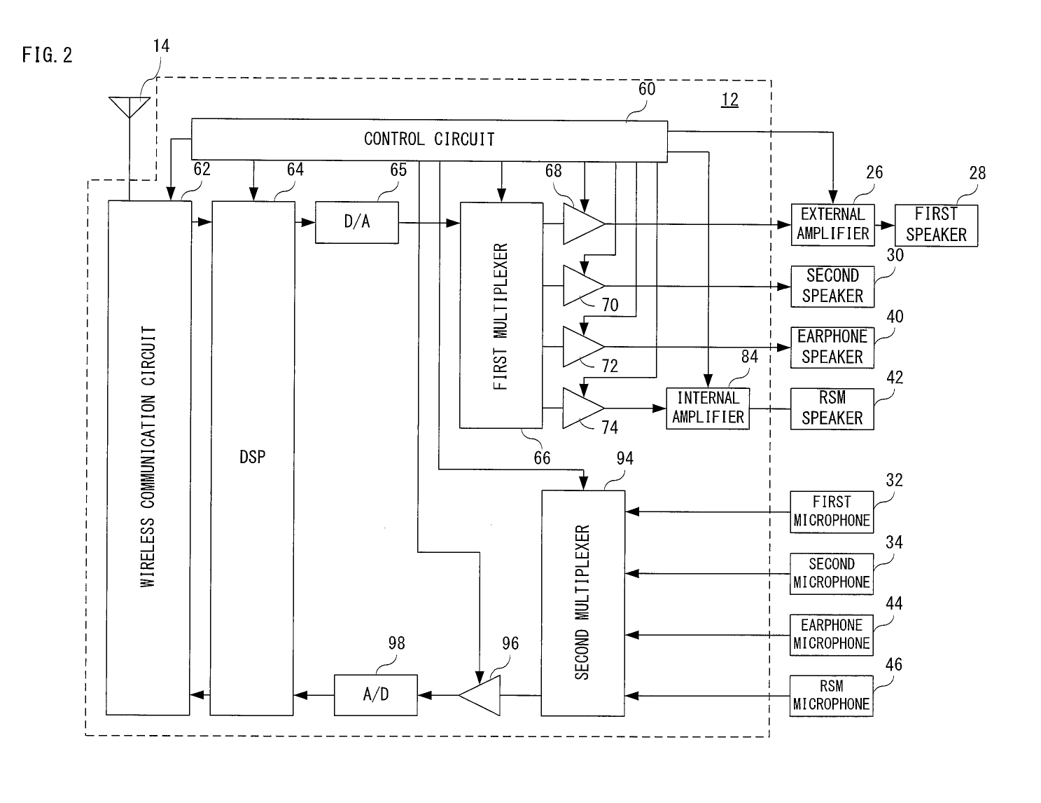

Within an inside of the processor 12, a digital voice signal is converted into an analog voice signal, and a voice or sound corresponding to the analog voice signal is output from the first speaker 28, the second speaker 30, a speaker of an earphone (earphone speaker) 40 (see FIG. 2) or a speaker of the RSM (RSM speaker) 42 (see FIG. 2). In addition, in a case that the voice or sound is output from the first speaker 28, the analog voice signal output from the processor 12 is amplified by the external amplifier (analog amplifier) 26. Furthermore, the earphone speaker 40 is a speaker provided in an earphone connected to the earphone jack 36. The RSM speaker 42 is a speaker provided in the RSM connected to the RSM terminal 38.

An analog voice signal of a voice or sound input through the first microphone 32, the second microphone 34, a microphone of the earphone (earphone microphone) 44 (see FIG. 2) or a microphone of the RSM (RSM microphone) 46 is converted into the digital voice signal in the inside of the processor 12. In addition, the earphone microphone 44 is a microphone provided in the earphone connected to the earphone jack 36, and the RSM microphone 46 is a microphone provided in the RSM connected to the RSM terminal 38. Furthermore, a PTT button is provided in the RSM, and key data thereof is also input to the processor 12 via the RSM terminal 38.

The first speaker 28 and the first microphone 32 are utilized in a case that a telephone conversation is performed in a state that the mobile phone 10 is separated from a face or head of the user (so-called hands-free), and the second speaker 30 and the second microphone 34 are utilized in a case that the mobile phone 10 is brought into contact with the face or head of the user to perform a telephone conversation. The earphone speaker 40 and the earphone microphone 44 both described later are constituted by a wired head set accessory (an earphone with microphone), and utilized in a case that a telephone conversation is performed by connecting the head set accessory to the earphone jack 36. The RSM speaker 42 and the RSM microphone 46 are constructed by a wired dedicated accessory (RSM), and utilized in a case that the RSM is connected to the RSM terminal 38 to perform a telephone conversation.

FIG. 2 is a block diagram showing the electrical structure of the inside of the processor 12 shown FIG. 1 and associated with an input and an output of the voice. As shown in FIG. 2, the processor 12 includes a control circuit 60 which is connected with the external amplifier 26, a wireless communication circuit 62, a DSP 64, a first multiplexer (MUX) 66, a first amplifier 68, a second amplifier 70, a third amplifier 72, a fourth amplifier 74, an internal amplifier 84, a second MUX 94 and a fifth amplifier 96.

The wireless communication circuit 62 is connected to the antenna 14 within the inside of the processor 12, and a transmission path and a reception path of the wireless communication circuit 62 are connected to the DSP 64. The DSP 64 functions as a sound circuit, and decodes a received voice signal and encodes a transmission voice signal. An input and an output of the voice signal to or from the DSP 64 are controlled by the control circuit 60.

The reception path of the wireless communication circuit 62 is connected to an input end of the first MUX 66 via the DSP 64 and a D/A converter 65. The first MUX 66 functions as a selector or switch circuit, and has four output ends. To respective output ends, analog amplifiers, that is, the first amplifier 68, the second amplifier 70, the third amplifier 72 and the fourth amplifier 74 are connected.

Specifically, an input end of the first amplifier 68 is connected with the first output end, and an output end of the first amplifier 68 is connected to an input end of the external amplifier 26. The second output end is connected to an input end of the second amplifier 70, and an output end of the second amplifier 70 is connected to the second speaker 30. The third output end is connected to an input end of the third amplifier 72, and an output end of the third amplifier 72 is connected to the earphone speaker 40 only in a case that the head set accessory is connected to the earphone jack 36. In FIG. 2, the earphone jack 36 and the RSM terminal 38 are omitted. The fourth output end is connected to an input end of the fourth amplifier 74, and an output end of the fourth amplifier 74 is connected to the RSM speaker 42 via the internal amplifier (analog amplifier) only in a case that the RSM is connected to the RSM terminal 38.

The second MUX 94 functions as a selector or switch circuit, and has four input ends. The first microphone 32 is connected to the first input end. The second microphone 34 is connected to the second input end. Only in a case that the earphone is connected to the earphone jack 36, the earphone microphone 44 is connected to the third input end. The RSM microphone 46 is connected to the fourth input end only in a case that the RSM is connected to the RSM terminal 38. An output end of the second MUX 94 is connected to an input end of the fifth amplifier (analog amplifier) 96. Furthermore, an output end of the fifth amplifier 96 is connected to the transmission path of the wireless communication circuit 62 via an A/D converter 98 and the DSP 64.

The control circuit 60 selects an output of the first MUX 66 and an input of the second MUX 94 in accordance with a conversation mode. In this embodiment shown, the conversation mode is classified into a speaker mode, a receiver mode, an earphone mode and an RSM mode. The first speaker 28 and the first microphone 32 are used in the speaker mode, and in the receiver mode, the second speaker 30 and the second microphone 34 are used. In the earphone mode, the earphone speaker 40 and the earphone microphone 44 are used. The RSM speaker 42 and the RSM microphone 46 are used in the RSM mode.

Therefore, if the speaker mode is set, the first output end of the first MUX 66 is selected and the first input end of the second MUX 94 is selected, by the control circuit 60. In a case that the receiver mode is set, by the control circuit 60, the second output end of the first MUX 66 is selected and the second input end of the second MUX 94 is selected. In a case that the earphone mode is set, the third output end of the first MUX 66 and the third input end of the second MUX 94 are selected, by the control circuit 60. Then, if the RSM mode is set, the fourth output end of the first MUX 66 is selected and the fourth input end of the second MUX 94 is selected, by the control circuit 60.

Although a detailed description is omitted, the conversation mode is set by the user with using a menu about the conversation; however, the earphone mode or the RSM mode may be automatically set by mechanically or electrically detecting the head set accessory (earphone with microphone) or the RSM is connected.

Furthermore, on/off (start/stop of the output) and a value of an amplifying factor of each of the external amplifier 26, the first amplifier 68, the second amplifier 70, the third amplifier 72, the fourth amplifier 74, the internal amplifier 84 and the fifth amplifier 96 are controlled by the control circuit 60.

In addition, although the key input device 16, the display driver 18, the display 20, the RAM 22 and the flash memory 24 are omitted in FIG. 2, these are connected to the control circuit 60.

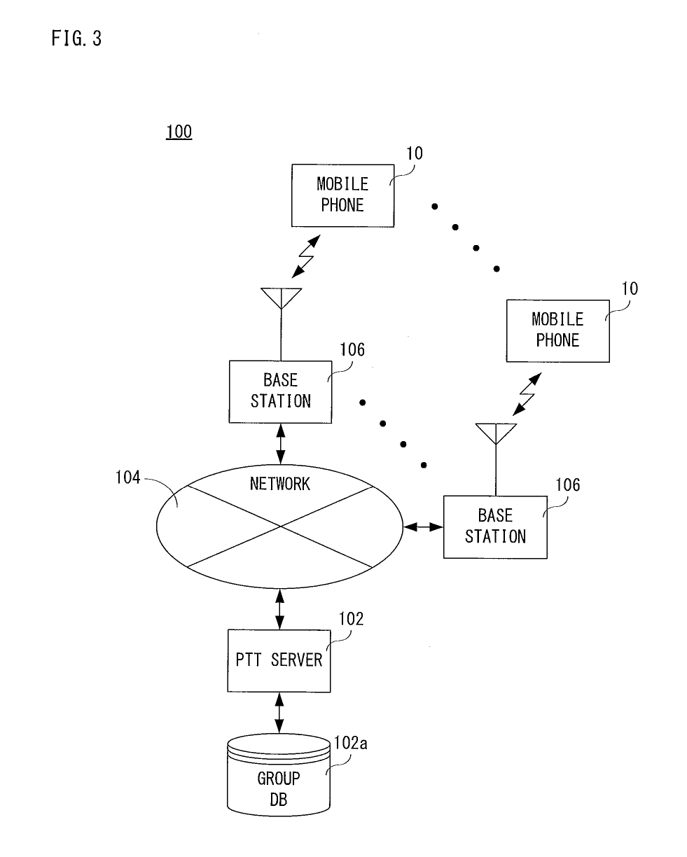

The wireless communication circuit 62 is a circuit for performing a wireless communication in a CDMA system. For example, if the user designates a telephone calling by using the key input device 16, the wireless communication circuit 62 performs a telephone calling process under instructions by the control circuit 60, and outputs a telephone calling signal via the antenna 14. The telephone calling signal is transmitted to a phone of the other end via a wireless base station and a communication network (including a mobile phone network) (see FIG. 3). Then, in the phone of the other end, if incoming processing is performed, a communication-capable state is established, and the control circuit 60 performs normal telephone conversation processing.

Here, the normal telephone conversation processing is specifically described. It is to be noted that the receiver mode is set as the conversation mode. A modulated voice signal sent from the phone of the other end is received by the antenna 14. A received modulated voice signal is subjected to demodulation processing by the wireless communication circuit 62 and to decode processing by the DSP 64 under instructions by the control circuit 60. A received voice signal obtained through such the processing is converted into an analog voice signal by the D/A converter 65 to be input to the first MUX 66. Then, under instructions by the control circuit 60, the analog voice signal is output from the second output end of the first MUX 66, and after amplified by the second amplifier 70, applied (sent) to the second speaker 30, whereby a received voice or sound corresponding to the analog voice signal is output from the second speaker 30.

On the other hand, a transmission voice signal fetched through the second microphone 34 is input to the second MUX 94 and output from the output end of the second MUX 94 under instructions by the control circuit 60, and further amplified by the fifth amplifier 96. An amplified transmission voice signal is converted into a digital voice signal by the A/D converter 98. The digital voice signal is subjected to encode processing by the DSP 64, and further modulation processing by the wireless communication circuit 62 to be output via the antenna 14. Therefore, a modulated voice signal is transmitted to the phone of the other end via the wireless base station and the communication network.

Furthermore, if a telephone calling signal from the phone of the other end is received by the antenna 14, the wireless communication circuit 62 notifies the control circuit 60 of a telephone call incoming. In response thereto, the processor 12 (the control circuit 60) controls the display driver 18 so as to display the sender information (telephone number, etc.) described in the incoming notification on the display 20. At approximately the same time, the control circuit 60 outputs a ringtone (may be also called as ringtone melody, ringtone voice) from the first speaker 28, for example.

Then, if the user performs an answering operation with using the talk key, the wireless communication circuit 62 performs incoming processing under instructions by the control circuit 60, and then, a communication-capable state is established, and the control circuit 60 performs the above-described normal telephone conversation process.

If a telephone conversation ending operation is performed by the end key after shifted to the telephone conversation-capable state, the control circuit 60 controls the wireless communication circuit 62 to transmit a telephone conversation ending signal to the phone of the other end. Then, after the transmission of the telephone conversation ending signal, the control circuit 60 terminates the telephone conversation process. Furthermore, in a case that the telephone conversation ending signal from the other end is previously received, the control circuit 60 terminates the telephone conversation process. In a case that the telephone conversation ending signal is received from the communication network not from the phone of the other end, the telephone conversation process is also terminated by the control circuit 60.

In addition, since except for differences in a speaker and a microphone to be used, in the speaker mode or the earphone mode, an operation similar to the above-described operation is performed, and the operation in the normal telephone conversation processing is not the essential content of the present invention, a description for the speaker mode or the earphone mode in the normal telephone conversation process is omitted.

An example of a PTT communication system (hereinafter, simply called as “system”) 100 using the above-described mobile phone 10 is shown in FIG. 3. As shown in FIG. 3, the system 100 includes a PTT server 102 which has a function for managing a mobile phone 10 requesting a PTT conversation (PTT communication) and a mobile phone 10 becoming the other end of the PTT conversation and a function for mediating a PTT conversation between a plurality of mobile phones 10. The PTT server 102 is connected to a plurality of wireless base stations 106 via a mobile phone network (network) 104. Furthermore, the system 100 includes a plurality of mobile phones 10 each of which performs a communication (a process of the PTT conversation) with another mobile phone 10 via the mobile phone network 104 and the wireless base station 106.

In the following, a process for the PTT conversation will be briefly described. It is to be noted that the receiver mode is set as the conversation mode.

If a mobile phone 10 issues a request for PTT conversation (PTT conversation request) to the PTT server 102, the PTT server 102 first performs mediation processing for the PTT conversation. In addition, the PTT conversation request includes a message that the PTT conversation is requested and a desired other end for the PTT conversation, i.e., identification information of another mobile phone 10. In this embodiment, the identification information is a telephone number of the mobile phone 10; however, instead of the telephone number, the identification information may be information substantially equal to the telephone number (information for specifying the mobile phone 10 other than the telephone number).

The PTT server 102 performs a calling (PTT call) for the PTT conversation to another mobile phone 10 (of the other end) upon reception of the PTT conversation request. In response thereto, if the notification of participation is sent to the PTT server 102 from the other mobile phone 10, the PTT server 102 sets the mobile phone 10 requesting the PTT conversation and the mobile phone 10 notifying the participation as a group performing the PTT conversation this time. That is, the PTT server 102 groups a plurality of mobile phones 10 each performing the PTT conversation and registers in a group database (group DB) 102a. Then, the PTT server 102 establishes a connection state with the mobile phone 10 requesting the PTT conversation and the mobile phone 10 notifying the participation, respectively. Thereafter, the PTT server 102 performs a PTT conversation process for the mobile phones 10 being grouped.

In addition, although a detailed description is omitted, when the PTT conversation is ended, the group registered in the group DB 102a is erased.

By depressing the PTT button, for example, a request to speak (a floor getting request) is issued in a mobile phone 10 in the group performing the PTT conversation. If the PTT server 102 receives the request to speak, the PTT server 102 determines whether or not any other user who is speaking (any other mobile phone 10 getting a floor) exists. It is to be noted that “floor” means “a right to speak”.

If no other user (mobile phone 10) who is speaking exists, the PTT server 102 gives a floor to the mobile phone 10 issuing a floor getting request. At this time, the PTT server 102 notifies the identification information of the mobile phone 10 which gets the floor (hereinafter, may be called as “floor getting information”) to all mobile phones 10 in the group of the PTT conversation.

If a given mobile phone 10 gets a floor, (the user of) the mobile phone 10 becomes a speakable state during the PTT button is being depressed. At this time, a voice of the user of the mobile phone 10 (speaking person) is input through the second microphone 34, and an analog voice signal (transmission voice signal) is output from the output end of the second MUX 94 under instructions by the control circuit 60. The transmission voice signal output from the second MUX 94 is amplified by the fifth amplifier 96, and input to the DSP 64 after converted into a digital voice signal by the A/D converter 98. The digital voice signal is packetized (encoded) by the DSP 64, and the packeted voice data (voice packet) is output via the wireless communication circuit 62 and the antenna 14. The voice packet output from the mobile phone 10 is transmitted to the PTT server 102 via the wireless base station 106 and the mobile phone network 104. Upon receipt of the voice packet, the PTT server 102 transmits via the mobile phone network 104 and the wireless base station 106 the voice packet to all of other mobile phones 10 being registered as the group with referring to the group DB 102a. If the voice packet from the PTT server 102 is received via the antenna 14, in each of the mobile phones 10, the voice packet is subjected to demodulation processing by the wireless communication circuit 62 under instructions by the control circuit 60, and then, the packetized data is decoded as original voice data by the DSP 64. The voice data output from (reproduced by) the DSP 64 is converted into an analog voice signal by the D/A converter 65, and under instructions by the control circuit 60, output from the second output end of the first MUX 66, and amplified by the second amplifier 70, and applied (transmitted) to the second speaker 30. Accordingly, a voice corresponding to the analog voice signal is output from the second speaker 30.

In addition, if any other user (mobile phone 10) who is speaking exists when a floor getting request is issued by a mobile phone 10, the PTT server 102 returns a refusal to the mobile phone 10 which issues the floor getting request. Furthermore, in a case that floor getting requests are issued from a plurality of mobile phones 10 in duplicate, the PTT server 102 determines a priority order for each mobile phone 10 in accordance with a predetermined rule, and applies a floor based on the priority orders. As the predetermined rule, there is a rule that the priority order is rendered higher in an order that the number of times of speaking is fewer or a rule that the priority order is rendered higher in an order that the number of times of refusal to the floor getting request is larger, for example.

If the PTT button (talk key) is released (turned-off) after getting the floor, the mobile phone 10 ends the speaking. If the PTT button is turned-off, the floor is released, and the PTT server 102 is notified that the floor is released. At this time, the PTT server 102 notifies all the mobile phones 10 in the group that the floor is released.

Although a detailed description is omitted, an operation in a case that the speaker mode, the earphone mode or the RSM mode is set as the conversation mode is similar to the above-described operation.

In addition, in a case that the speaker mode is set, the voice of the user (speaking person) of the mobile phone 10 is input through the first microphone 32, and a transmission voice signal is output from the output end of the second MUX 94 under instructions by the control circuit 60. The transmission voice signal output from the second MUX 94 is amplified by the fifth amplifier 96 to be converted into a digital voice signal by the A/D converter 98. The digital voice signal is packetized by the DSP 64, and a voice packet is output via the wireless communication circuit 62 and the antenna 14. On the other hand, in the mobile phone 10, if the voice packet from the PTT server 102 is received via the antenna 14, the voice packet is subjected to the demodulation processing by the wireless communication circuit 62 and decoded to the original voice data by the DSP 64 under instructions by the control circuit 60. The voice data output from the DSP 64 is converted into an analog voice signal by the D/A converter 65, and under instructions by the control circuit 60, output from the first output end of the first MUX 66 and then amplified by the first amplifier 68. The analog voice signal amplified by the first amplifier 68 is amplified by the external amplifier 26, and a voice corresponding to the analog voice signal amplified by the external amplifier 26 is output from the first speaker 28.

In a case that the earphone mode is set, the voice of the user (speaking person) of the mobile phone 10 is input through the earphone microphone 44, and a transmission voice signal is output from the output end of the second MUX 94 under instructions by the control circuit 60. The transmission voice signal output from the second MUX 94 is amplified by the fifth amplifier 96 to be converted into a digital voice signal by the A/D converter 98. The digital voice signal is packetized by the DSP 64, and a voice packet is output via the wireless communication circuit 62 and the antenna 14. On the other hand, in the mobile phone 10, if the voice packet from the PTT server 102 is received via the antenna 14, the voice packet is subjected to the demodulation processing by the wireless communication circuit 62 and decoded to the original voice data by the DSP 64 under instructions by the control circuit 60. The voice data output from the DSP 64 is converted into an analog voice signal by the D/A converter 65, and under instructions by the control circuit 60, output from the third output end of the first MUX 66, and then, amplified by the third amplifier 72. A voice corresponding to the analog voice signal amplified by the third amplifier 72 is output from the earphone speaker 40.

Furthermore, in a case that the RSM mode is set, the voice of the user (speaking person) of the mobile phone 10 is input through the RSM microphone 46, and a transmission voice signal is output from the output end of the second MUX 94 under instructions by the control circuit 60. The transmission voice signal output from the second MUX 94 is amplified by the fifth amplifier 96 to be converted into a digital voice signal by the A/D converter 98. The digital voice signal is packetized by the DSP 64, and a voice packet is output via the wireless communication circuit 62 and the antenna 14. On the other hand, in the mobile phone 10, if the voice packet from the PTT server 102 is received via the antenna 14, the voice packet is subjected to the demodulation processing by the wireless communication circuit 62 and decoded to the original voice data by the DSP 64 under instructions by the control circuit 60. The voice data output from the DSP 64 is converted into an analog voice signal by the D/A converter 65, and under instructions by the control circuit 60, output from the fourth output end of the first MUX 66, and then, amplified by the fourth amplifier 74. The analog voice signal amplified by the fourth amplifier 74 is amplified by the internal amplifier 84 and a voice corresponding to the analog voice signal amplified by the internal amplifier 84 is output from the RSM speaker 42.

In such a mobile phone 10, normally, an output of the speaker (28, 30, 40, 42), that is, an output of the amplifier (26, 68, 70, 72, 74, 84) is maintained (turned-on) at a time of the PTT conversation. Therefore, if no mobile phone 10 getting the floor exists, there is an occasion that a noise (white noise) is generated from the speaker (28, 30, 40, 42). Such a noise is unpleasant for the user and in a case that the PTT conversation is to be recorded, the noise is also recorded unintentionally.

Therefore, in this embodiment shown, at a time of non-use that a voice or sound is not output from the speaker(28, 30, 40, 42), a noise is prevented from being generated from the speaker (28, 30, 40, 42) by turning-off the amplifier (26, 68, 70, 72, 74, 84) provided at a stage preceding to the speaker (28, 30, 40, 42).

Here, a stage preceding to the speaker (28, 30, 40, 42) means a preceding stage in a case that a transmission (output) direction of a signal is defined as the forth and back in a direction from an input to an output. Therefore, in a case that the amplifier (26, 68, 70, 72, 74, 84) is provided at a preceding stage of the speaker (28, 30, 40, 42), the voice signal is transmitted from the amplifier (26, 68, 70, 72, 74, 84) to the speaker (28, 30, 40, 42).

More specifically, if any other mobile phone 10 gets a floor, the amplifier (26, 68, 70, 72, 74, 84) is turned-on, and in a case that no mobile phone 10 gets a floor, the amplifier (26, 68, 70, 72, 74, 84) is turned-off.

Furthermore, if any other mobile phone 10 (other person) gets a floor after an input and output to or from the DSP 64 is started, the amplifier (26, 68, 70, 72, 74, 84) is turned-on to start an output, and in a case that the other person releases the floor, strictly saying, in a case that no one gets the floor, by turning-off the amplifier (26, 68, 70, 72, 74, 84), a noise due to on/off of the amplifier (26, 68, 70, 72, 74, 84) is prevented from being generated from the speaker (28, 30, 40, 42).

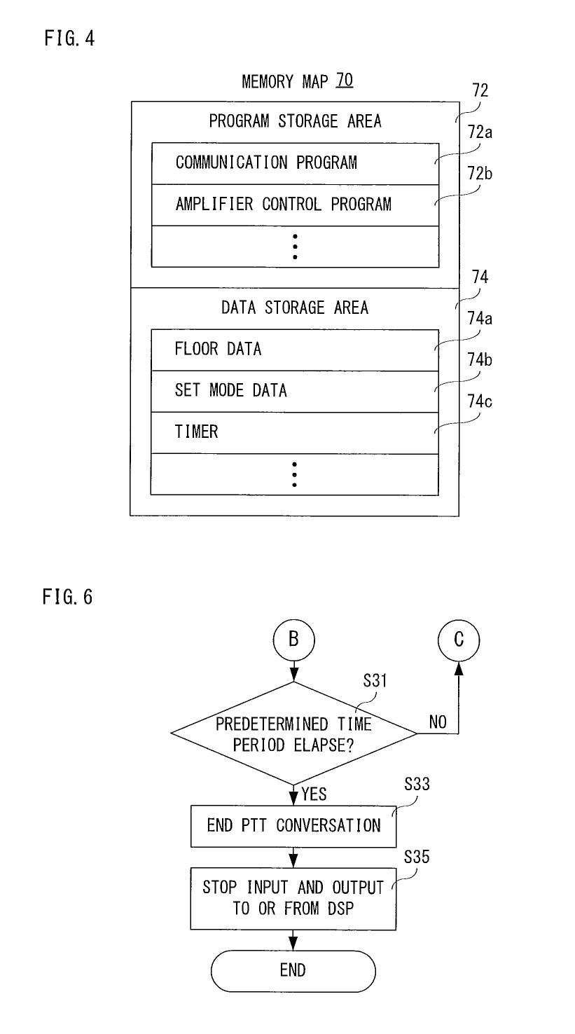

FIG. 4 is a view showing an example of a memory map 70 of the RAM 24 shown in FIG. 1. As shown in FIG. 4, the RAM 24 includes a program storage area 72 and a data storage area 74.

The program storage area 72 is stored with a communication program 72a, an amplifier control program 72b, etc. The communication program 72a is a program for performing a telephone conversation or communication with another telephone, or communication with another computer. The amplifier control program 72b is a program for controlling on/off and a value of an amplifying factor of the amplifier (26, 68, 70, 72, 74, 84, 96).

Although not shown, the program storage area 72 is further stored with programs (application programs) for various functions such as a schedule, alarm, address book, etc., held by the mobile phone.

The data storage area 74 is stored with floor data 74a and set mode data 74b. Furthermore, the data storage area 74 is provided with a timer 74c. The floor data 74a is data about floor getting information notified from the PTT server 102, and renewed at every time of notification. The set mode data 74b is data indicating what conversation mode is being set, and constituted by a 2-bit register. Specifically, if the speaker mode is set, a data value “00” is set in the register, and if the receiver mode is set, a data value “01” is set in the register. A data value “10” is set in the register if the earphone mode is set. If the RSM mode is set, a data value “11” is set in the register. The timer 74c is a timer for counting a time period of a state that no one is speaking, that is, a state that no mobile phone 10 gets a floor.

Although not shown, the data storage area 74 may be stored with key data according to an operation by the user and other data necessary for executing various kinds of programs, and may be provided with other timer(s) (counter(s)) and register(s).

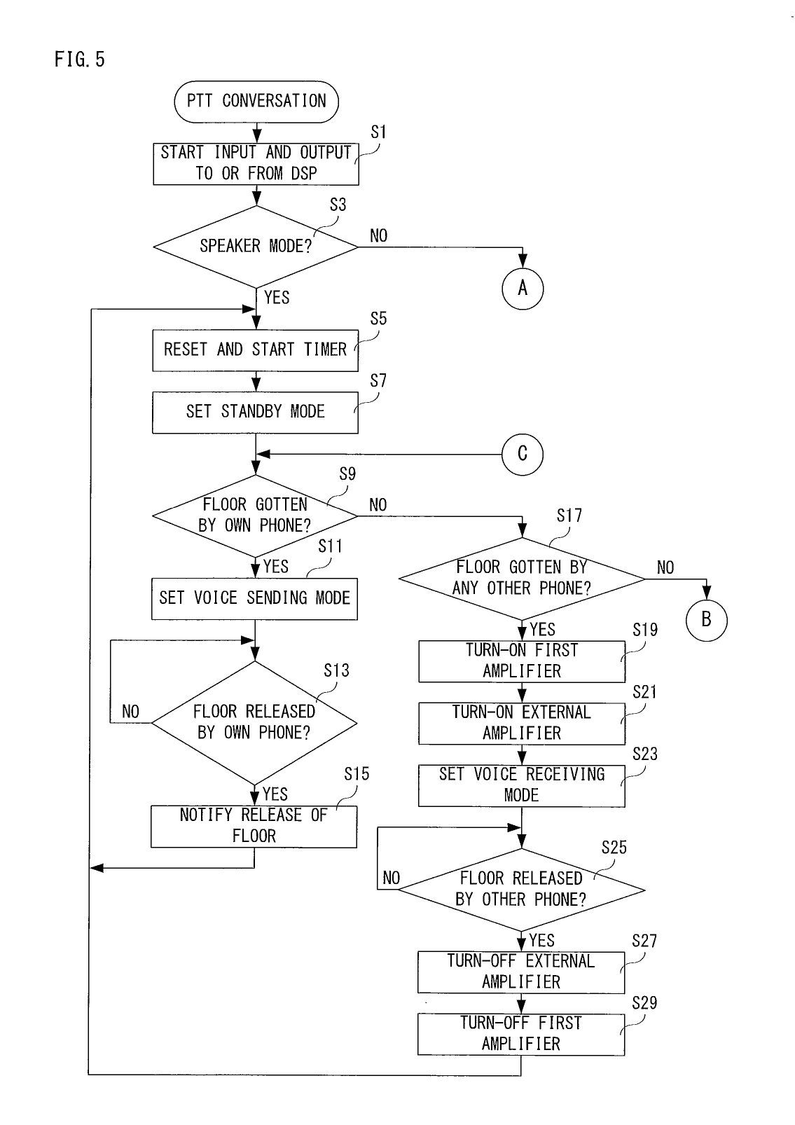

FIG. 5 to FIG. 12 show a flowchart of a PTT conversation process by the processor 12 (control circuit 60). In the following, the PTT conversation process will be described, but, as to the same or similar processing executed in each of the speaker mode, receiver mode, earphone mode and RSM mode, a duplicate description will be omitted as possible to make simple description.

As shown in FIG. 5, the processor 12 (control circuit 60) starts an input and output to or from the DSP 64 in a step S1 when the PTT conversation process is started. It is to be noted that at a time that the PTT conversation process is started, the external amplifier 26, the first amplifier 68, the second amplifier 70, the third amplifier 72, the fourth amplifier 74 and the internal amplifier 84 are all in a turned-off state (stopped to output).

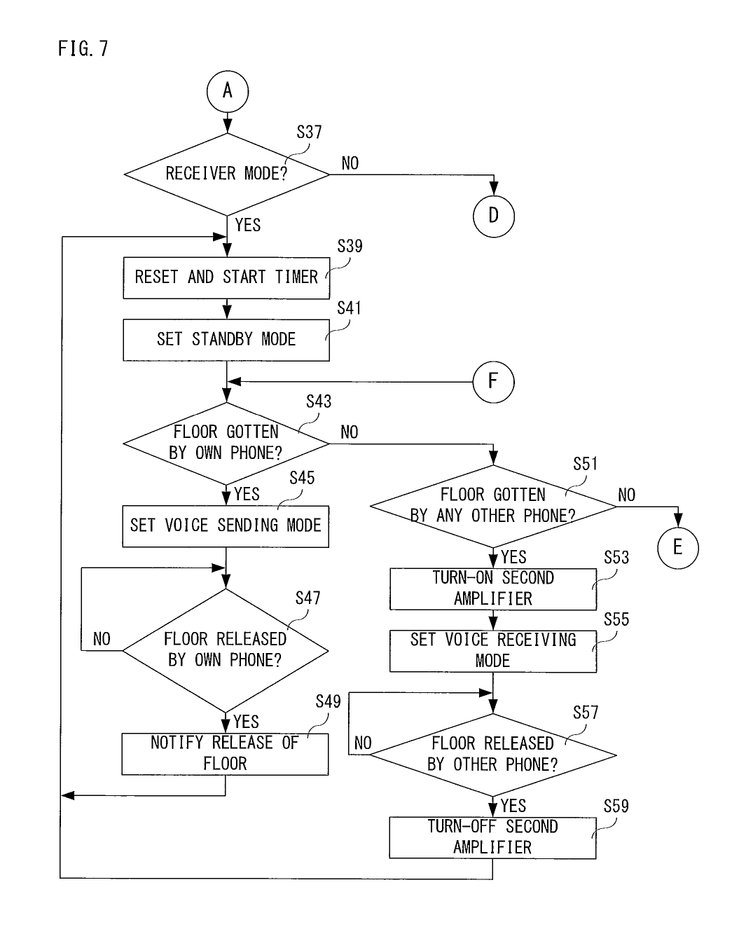

In a next step S3, it is determined whether or not the speaker mode is set. That is, the processor 12 (control circuit 60) determines whether or not the set mode data 74b indicates “00”. If “NO” is determined in the step S3, that is, if the speaker mode is not set, the process proceeds to a step S37 shown in FIG. 7. If “YES” is determined in the step S3, that is, if the speaker mode is set, in a step S5, the timer 74c is reset and started, and in a step S7, a standby mode is set. Here, the processor 12 (control circuit 60) displays an icon indicating that the standby mode is being set on the display 20 by controlling the display driver 16. Instead, a character string indicating that the standby state is being set may be displayed. The standby state means a state for waiting that a floor is gotten by a user's own mobile phone 10 or any other person's mobile phone, that is, a state that no one is speaking.

In a succeeding step S9, it is determined whether or not a floor is gotten by the user's own mobile phone 10. That is, the processor 12 (control circuit 60) determines whether or not the identification information of the user's own mobile phone 10 is described in the floor getting information that is notified from the PTT server 102. If “YES” is determined in the step S9, that is, if the floor is gotten by the user's own mobile phone 10, in a step S11, a voice sending mode is set. Here, the processor 12 (control circuit 60) displays an icon showing a state capable of sending a voice (the floor is being gotten) on the display 20 by controlling the display driver 16. Instead, a character string indicating a state capable of sending a voice (the floor is being gotten) may be displayed. The state capable of sending a voice means a state that it is possible to speak (a state that the floor is gotten). At this time, the control circuit 60 selects an input from the second input end by designating the second MUX 94. Therefore, if the user speaks during when the user depresses the PTT button, the speaking (voice) is input from the first microphone 32, and the input voice is subjected to the above-described processing, and then, corresponding voice data (voice packet) is transmitted to the PTT server 102. Such an input of a voice and the transmission processing of the voice packet corresponding to an input voice are performed in a process separated from the PTT conversation process.

In a succeeding step S13, it is determined whether or not the floor is released by the user's own mobile phone 10. Here, the processor 12 (control circuit 60) determines whether or not the PTT button is released (turned-off) by detecting presence or absence of an input of key data corresponding to the PTT button. If “NO” is determined in the step S13, that is, if the floor is not released by the user's own mobile phone 10, the process returns to the same step S13 with no operation. On the other hand, if “YES” is determined in the step S13, that is, if the floor is released, in a step S15, the release of the floor by the user's own mobile phone 10 is notified to the PTT server 102, and thereafter, the process returns to the step S5.

If “NO” is determined in the step S9, that is, if the floor is not gotten by the user's own mobile phone 10, in a step S17, it is determined whether or not any other person gets a floor. Here, the processor 12 (control circuit 60) determines whether or not the identification information of any other mobile phone 10 is described in the floor getting information that is notified from the PTT server 102.

If “NO” is determined in the step S17, that is, if no other person gets the floor, the process proceeds to a step S31 shown in FIG. 6. On the other hand, if “YES” is determined in the step S17, that is, if any other person gets the floor, in a step S19, the first amplifier 68 is turned-on, and the external amplifier 26 is turned-on in a step S21, and then, in a step S23, a voice receiving mode is set. In this step S23, the processor 12 (control circuit 60) displays an icon indicative of a state capable of receiving a voice on the display 20 by controlling the display driver 18. Instead, a character string indicative of a state capable of receiving a voice may be displayed. The state capable of receiving a voice means a state that it is possible to hear the speaking by any other person. At this time, the control circuit 60 makes the first MUX 66 select the first output end. Therefore, if the voice packet from the PTT server 102 is received via the antenna 14, the above-described processing is applied to the voice packet, and a voice corresponding to the voice packet is output from the first speaker 28. Such the reception processing of the voice packet and an output of the voice corresponding to the voice packet are performed in a process separated from the PTT conversation process.

Subsequently, in a step S25, it is determined whether or not the floor is released by any other person. Here, the processor 12 (control circuit 60) determines whether or not a notification that the floor is released by the other person is received from the PTT server 102. If “NO” is determined in the step S25, that is, if the floor is not released by the other person, the process returns to the step S25 with no operation. If “YES” is determined in the step S25, that is, if the floor is released by the other person, in a step S27, the external amplifier 26 is turned-off, and the first amplifier 68 is turned-off in a step S29, and then, the process returns to the step S5.

As shown in FIG. 6, in the step S31, it is determined whether or not a predetermined time period elapses. Here, the processor 12 (control circuit 60) determines whether or not a count value of the timer 74c reaches the predetermined time period (5 to 10 seconds, for example). If “NO” is determined in the step S31, that is, if the predetermined time period does not elapse, the process returns to the step S9 shown in FIG. 5. If “YES” is determined in the step S31, that is, if the predetermined time period elapses, the PTT conversation is ended, and in a step S35, an input and output to or from the DSP 64 is stopped to terminate the PTT conversation process.

In this embodiment, when a time that a floor is not gotten by any mobile phones 10 included in the group performing the PTT conversation, that is, a time that no one speaks reaches the predetermined time period, the PTT conversation is ended; however, the PTT conversation is also ended in a case that the user designates the end of the PTT conversation. For example, if the end key is operated, the end of the PTT conversation is designated.

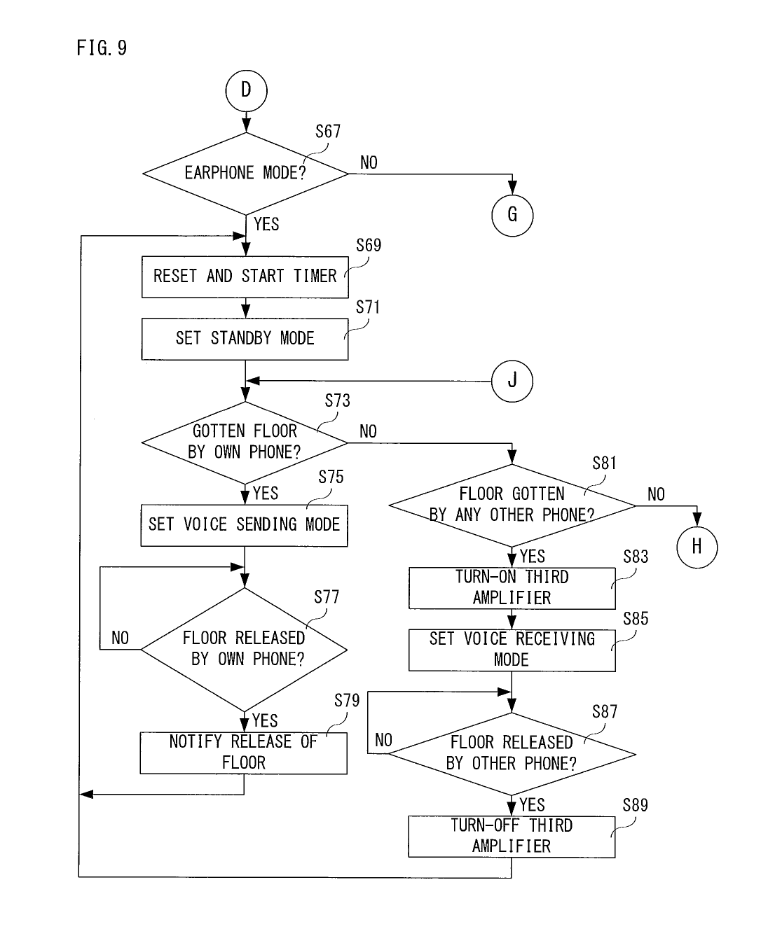

As shown in FIG. 7, in the step S37, it is determined whether or not the receiver mode is set. Here, the processor 12 (control circuit 60) determines whether or not the set mode data 74b indicates “01”. If “NO” is determined in the step S37, that is, if the receiver mode is not set, the process proceeds to a step S67 shown in FIG. 9. On the other hand, if “YES” is determined in the step S37, that is, if the receiver mode is set, in a step S39, the timer 74c is reset and started, and in a step S41, a standby mode is set.

In a next step S43, it is determined whether or not a floor is gotten by the user's own mobile phone. If “YES” is determined in the step S43, in a step S45, the voice sending mode is set. In the step S45, the control circuit 60 causes the second MUX 94 to select an input to the second input end.

Then, in a step S47, it is determined whether or not the floor is released by the user's own mobile phone. If “NO” is determined in the step S47, the process returns to the step S47 with no operation. On the other hand, if “YES” is determined in the step S47, in a step S49, the release of the floor is notified to the PTT server 102, and then, the process returns to the step S39.

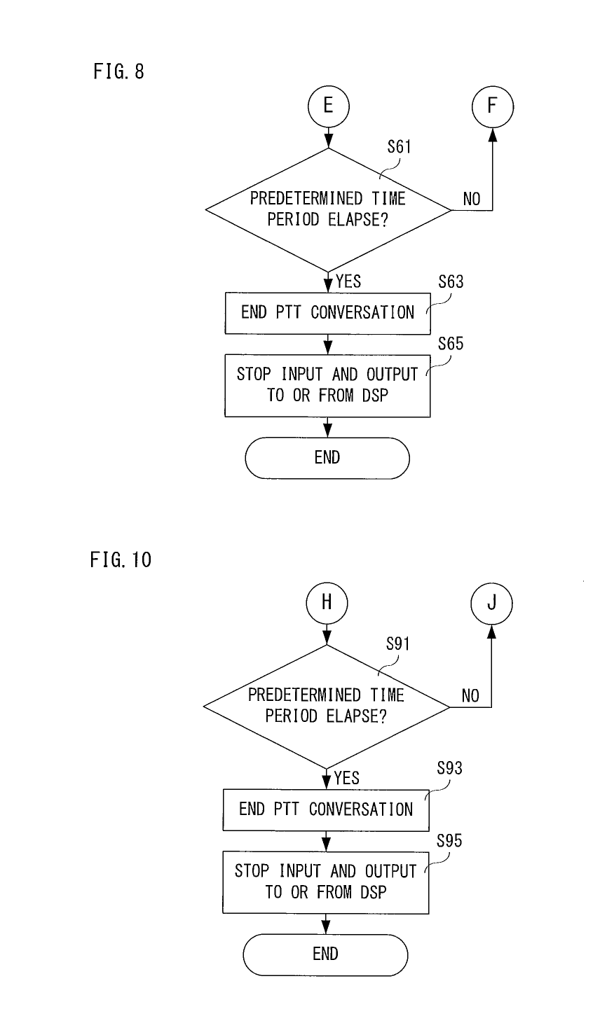

Furthermore, if “NO” is determined in the step S43, in a step S51, it is determined whether or not a floor is gotten by any other mobile phone. If “NO” is determined in the step S51, the process proceeds to a step S61 shown in FIG. 8 described later. On the other hand, if “YES” is determined in the step S51, in a step S53, the second amplifier 70 is turned-on, and the voice receiving mode is set in a step S55 where the control circuit 60 causes the first MUX 66 to select the second output end. Therefore, if a voice packet from the PTT server 102 is received, the aforementioned processing is applied to the voice packet such that a voice corresponding to the voice packet is output from the second speaker 30.

Subsequently, in a step S57, it is determined whether or not the floor is released by the other mobile phone. If “NO” is determined in the step S57, the process returns to the same step S57. If “YES” is determined in the step S57, that is, if the other mobile phone releases the floor, the second amplifier 70 is turned-off in a step S59, and then, the process returns to the step S39.

As shown in FIG. 8, in the step S61, it is determined whether or not a predetermined time period elapses. If “NO” is determined in the step S61, the process returns to the step S43 shown in FIG. 7. If “YES” is determined in the step S61, the PTT conversation is ended in a step S63, and in a step S65, an input and output to or from the DSP 64 is stopped to terminate the PTT conversation process.

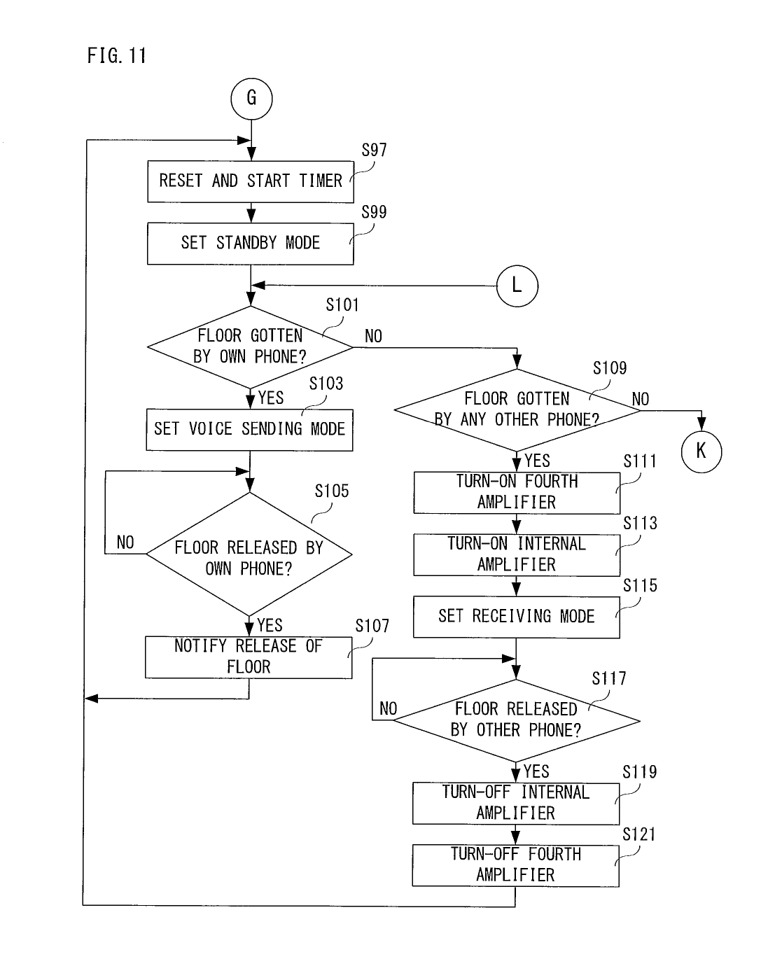

As shown in FIG. 9, in the step S67, it is determined whether or not the earphone mode is set. Here, the processor 12 (control circuit 60) determines whether or not the set mode data 74b indicates “10”. If “NO” is determined in the step S67, that is, if the set mode data 74b indicates “11”, it is determined that the RSM mode is set, and then, the process proceeds to a step S97 shown in FIG. 11. If “YES” is determined in the step S67, that is, if being in the earphone mode, in a step S69, the timer 74c is reset and started, and in a step S71, a standby mode is set.

Next, in a step S73, it is determined whether or not a floor is gotten by the user's own mobile phone. If “YES” is determined in the step S73, in a step S75, the voice sending mode is set. Here, the control circuit 60 causes the second MUX 94 to select an input from the third input end. Accordingly, a voice of the user is input from the earphone microphone 44, and the voice is subjected to the aforementioned processing, and then, a voice packet corresponding to the voice of the user is transmitted to the PTT server 102.

Subsequently, in a step S77, it is determined whether or not the floor is released by the user's own mobile phone. If “NO” is determined in the step S77, the process returns to the step S77 with no operation. On the other hand, if “YES” is determined in the step S77, in a step S79, the release of the floor is notified to the PTT server 102, and then, the process returns to the step S69.

In addition, if “NO” is determined in the step S73, in a step S81, it is determined whether or not a floor is gotten by any other mobile phone. If “NO” is determined in the step S81, the process proceeds to a step S91 shown in FIG. 10. On the other hand, if “YES” is determined in the step S81, in a step S83, the third amplifier 72 is turned-on, and the voice receiving mode is set in a step S85 where the control circuit 60 causes the first MUX 66 to select the third output end. Therefore, if a voice packet from the PTT server 102 is received, the aforementioned processing is applied to the voice packet such that a voice corresponding to the voice packet is output from the earphone speaker 40.

Subsequently, in a step S87, it is determined whether or not the floor is released by the other mobile phone. If “NO” is determined in the step S87, the process returns to the same step S87 with no operation. If “YES” is determined in the step S87, that is, if the other mobile phone releases the floor, the third amplifier 72 is turned-off in a step S89, and then, the process returns to the step S69.

As shown in FIG. 10, in the step S91, it is determined whether or not a predetermined time period elapses. If “NO” is determined in the step S91, the process returns to the step S73 shown in FIG. 9. If “YES” is determined in the step S91, the PTT conversation is ended in a step S93, and in a step S95, an input and output to or from the DSP 64 is stopped to terminate the PTT conversation process.

As shown in FIG. 11, in the step S97, the timer 74c is reset and started, and in a next step S99, a standby mode is set. Subsequently, in a step S101, it is determined whether or not a floor is gotten by the user's own mobile phone. If “YES” is determined in the step S101, the voice sending mode is set in a step S103 where the control circuit 60 causes the second MUX 94 to select the fourth output end. Therefore, the voice of the user is input from the RSM microphone 46, and the voice is subjected to the aforementioned processing, and then, a voice packet corresponding to the voice of the user is transmitted to the PTT server 102.

In a next step S105, it is determined whether or not the floor is released by the user's own mobile phone. If “NO” is determined in the step S105, the process returns to the same step S105 with no operation. On the other hand, if “YES” is determined in the step S105, in a step S107, the release of the floor is notified to the PTT server 102, and then, the process returns to the step S97.

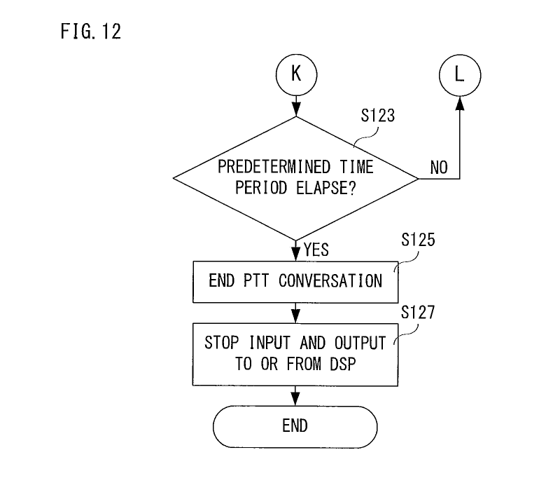

On the other hand, if “NO” is determined in the step S101, in a step S109, it is determined whether or not a floor is gotten by any other mobile phone. If “NO” is determined in the step S109, the process proceeds to a step S123 shown in FIG. 12. On the other hand, if “YES” is determined in the step S109, in a step S111, the fourth amplifier 74 is turned-on, in a step S113, the internal amplifier 84 is turned-on. And the voice receiving mode is set in a step S115 where the control circuit 60 causes the first MUX 66 to select the fourth output end. Therefore, if a voice packet from the PTT server 102 is received, the aforementioned processing is applied to the voice packet such that a voice corresponding to the voice packet is output from the RSM speaker 42.

Subsequently, in a step S117, it is determined whether or not the floor is released by the other mobile phone. If “NO” is determined in the step S117, the process returns to the same step S117 with no operation. If “YES” is determined in the step S117, the internal amplifier 84 is turned-off in a step S119 and the fourth amplifier 74 is turned-off in a step S121, and then, the process returns to the step S97.

As shown in FIG. 12, in the step S123, it is determined whether or not a predetermined time period elapses. If “NO” is determined in the step S123, the process returns to the step S101 shown in FIG. 11. If “YES” is determined in the step S123, the PTT conversation is ended in a step S125, and in a step S127, an input and output to or from the DSP 64 is stopped to terminate the PTT conversation process.

According to this embodiment shown, in the PTT conversation, if a floor is gotten by any other person's mobile phone, an output from an amplifier is started, and when the floor is released by the other person's mobile phone, the output of the amplifier is stopped, and therefore, it is possible to stop the output of the amplifier in a case that it is not necessary to output a voice or sound from a speaker. Therefore, it is possible to prevent a white noise from being generated from the speaker.

Furthermore, according to this embodiment shown, in the PTT conversation, since an amplifier is turned-on/-off from a time that the input and output to or from the DSP is started to a time that the input and output to or from the DSP is ended, it is also possible to prevent a noise from being generated from the speaker due to the turning-on/-off of the amplifier.

In addition, in this embodiment shown, a voice packet is transmitted and received in the PTT conversation, but not limited to such a system, and it is possible to transmit and receive other contents such as a video (image), sound (music), and character other than the voice packet.

This embodiment is described in a case that the mobile phone is utilized as the electronic equipment, but it is possible to use a digital transceiver in other embodiments.

Furthermore, in this embodiment, a dedicated button is utilized as the PTT button, but a functional key may be utilized.

An embodiment is electronic equipment which performs a half-duplex communication with one or more other equipment, comprising: an outputting module which outputs a voice corresponding to a received voice signal; an amplifying module which is provided at a preceding stage of the outputting module and amplifies the received voice signal; an amplifying controlling module which starts an output of the amplifying module when a floor is gotten by any other equipment, and stops the output of the amplifying module at least a time when a floor is not gotten by any other equipment.

In the embodiment, the electronic equipment (10) performs the half-duplex communication with one or more other equipment (10 or the like). The outputting module (28, 30, 40, 42) outputs a voice corresponding to a received voice signal. The amplifying module (26, 68, 70, 72, 74, 84) is provided at a stage preceding to the outputting module, and amplifies the received voice signal. The amplifying controlling module (60, S19, S21, S27, S29, S53, S59, S83, S89, S111, S113, S119, S121) starts an output of the amplifying module when a right to speak (floor) is gotten by any other equipment, and stops the output of the amplifying module at least a time when a right to speak (floor) is not gotten by any other equipment. That is, when a right to speak (floor) is gotten by a user's own electronic equipment, and when all the equipment performing the half-duplex communication do not have a right to speak (floor), the output of the amplifying module is stopped. Here, a stage preceding to the outputting module means a preceding stage in a case that the forward and backward of the transmission direction of the signal is defined in a direction from the input to the output. Therefore, in a case where the amplifying module is provided at a stage preceding to the outputting module, the voice signal is transmitted to the outputting module from the amplifying module.

According to the embodiment, since an output of the amplifying module is started when a floor is gotten by any other equipment, and the output of the amplifying module is stopped at least a time when a floor is not gotten by any other equipment, it is possible to stop the output of the amplifying module in a case that it is not necessary to output a voice or sound. Therefore, it is possible to prevent a noise from being generated from the outputting module.

Another embodiment is the electronic equipment which further comprises a communication module which performs at least a half-duplex communication, an inputting/outputting module provided between the communication module and the amplifying module and to or from which a voice signal is input or output, and an input/output controlling module which controls start and stop of the input/output to or from the inputting/outputting module, wherein the amplifying controlling module starts or stops the output of the amplifying module during a time that the input/output to or from the inputting/outputting module is started by the input/output controlling module and a time that the input/output to or from the inputting/outputting module is stopped by the input/output controlling module.

In this embodiment, the communication module (62) performs at least a half-duplex communication. The inputting/outputting module (64) is provided between the communication module and amplifying module, and to or from which the voice signal is input or output. The input/output controlling module (60, S1, S35, S65, S95, S127) controls the start and stop of the input/output to or from the inputting/outputting module. That is, in a case where the input/output of the voice signal to or from the inputting/outputting module is performed, the output of the amplifying module is started or stopped.

According to this embodiment, it is possible to prevent a noise due to the start or stop of the output of the amplifying module from being generated from the outputting module.

A further embodiment is a non-transitory computer readable storage medium storing an output controlling program executable by a processor of electronic equipment performing a half-duplex communication with one or more other equipment, wherein the output controlling program causes the processor to perform: starting an output of the amplifying module which is provided at a preceding stage of the outputting module and amplifies a received voice signal when a floor is gotten by any other equipment, and stopping the output of the amplifying module at least a time when the floor is not gotten by any other equipment.

In the further embodiment, it is possible to prevent a noise from being generated from the outputting module.

A still further embodiment is an output controlling method in electronic equipment performing a half-duplex communication with one or more other equipment, comprising steps of: starting an output of the amplifying module which is provided at a preceding stage of the outputting module and amplifies a received voice signal when a floor is gotten by any other equipment, and stopping the output of the amplifying module at least a time when the floor is not gotten by any other equipment.

In the further embodiment, it is possible to prevent a noise from being generated from the outputting module.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. Electronic equipment which performs a half-duplex communication with one or more other equipment, comprising:
an outputting module which outputs a voice corresponding to a received voice signal;
an amplifying module which is provided at a preceding stage of the outputting module and amplifies the received voice signal;
an amplifying controlling module which starts an output of the amplifying module when a floor is gotten by any other equipment, and stops the output of the amplifying module at least a time when a floor is not gotten by any other equipment.

2. The electronic equipment according to claim 1, further comprising;
a communication module which performs at least a half-duplex communication;
an inputting/outputting module provided between the communication module and the amplifying module and to or from which a voice signal is input or output, and
an input/output controlling module which controls start and stop of the input/output to or from the inputting/outputting module, wherein
the amplifying controlling module starts or stops the output of the amplifying module during a time that the input/output to or from the inputting/outputting module is started by the input/output controlling module and a time that the input/output to or from the inputting/outputting module is stopped by the input/output controlling module.

3. A non-transitory computer readable storage medium storing an output controlling program executable by a processor of electronic equipment performing a half-duplex communication with one or more other equipment, wherein the output controlling program causes the processor to perform:
starting an output of the amplifying module which is provided at a preceding stage of the outputting module and amplifies a received voice signal when a floor is gotten by any other equipment, and
stopping the output of the amplifying module at least a time when the floor is not gotten by any other equipment.

4. An output controlling method in electronic equipment performing a half-duplex communication with one or more other equipment, comprising steps of:
starting an output of the amplifying module which is provided at a preceding stage of the outputting module and amplifies a received voice signal when a floor is gotten by any other equipment, and
stopping the output of the amplifying module at least a time when the floor is not gotten by any other equipment.
